(19) United States
(12) Patent Application Publication
(10) Pub. No.: US 2010/0243690 A1
(43) Pub. Date: Sep. 30, 2010

(54) Weapon Holster with Adjustable Draw Angle, in Particular for Hand Firearms and Latching Joint Unit, in Particular for Weapon Holsters

(75) Inventor: Helmut Lerch, Essen (DE)

Correspondence Address: GUDRUN E. HUCKETT DRAUDT, SCHUBERTSTR. 15A, WUPPERTAL, 42289, DE

(73) Assignee: Das Land Nordrhein-Westfalen, Innenministerium NRW Landesamt fur zentrale polizeiliche Dienste, Duisburg (DE)

(21) Appl. No.: 12/740,698

(22) PCT Filed: Oct. 30, 2008
(86) PCT No.: PCT/IB08/03996

§ 371 Date: Jun. 16, 2010

(30) Foreign Application Priority Data
Oct. 30, 2007 (DE) 202007015150.0
Dec. 20, 2007 (DE) 202007017948.0

(51) Int. Cl. F41C 33/02; B23P 17/00

(52) U.S. Cl. 224/198; 224/663; 224/243; 29/401.1

(57) ABSTRACT

In a weapon holster with adjustable draw angle, in particular for hand firearms, comprising a holster web for fastening the holster to a belt, a coupling or the like and a holster receptacle for holding a weapon, in particular a hand firearm, wherein the holster web and the holster receptacle are connected together and can rotate about an axis of rotation such that the draw angle defined by the relative position between the holster web and the holster receptacle can be adjusted, latch protrusions between the holster web and the holster receptacle and latch depressions that are partially complementary to said protrusions are provided in which the latch protrusions engage for fixing various draw angles, wherein the adjustment of the draw angle is only accomplished by applying a torque that releases the latching protrusions from the latch depressions and rotating the holster web and holster receptacle about the axis of rotation in opposite directions, and wherein the torque is adjustable.

### TECHNICAL FIELD OF THE INVENTION

The invention concerns a weapon holster with adjustable draw angle, in particular for hand firearms, comprising a holster plate for attaching a holster to a belt, duty belt, or the like and a holster receptacle for receiving a weapon, in particular a hand firearm, wherein the holster plate and the holster receptacle are connected to one another rotatably about an axis of rotation such that the draw angle defined by the relative position between holster plate and holster receptacle is adjustable. The invention concerns moreover a latching joint unit, in particular for weapon holsters, by means of which different relative positions of parts that are connected to one another by the latching joint unit are adjustable.

### BACKGROUND OF THE INVENTION

Weapon holsters of the aforementioned kind are known, for example, from U.S. 2007/0023468 A1. They usually serve for carrying a weapon, in particular a hand firearm, on a belt, a duty belt or the like, wherein the so-called draw angle, at which the weapon is drawn from the holster receptacle and that is defined by the relative position of holster plate and holster receptacle serving as a receptacle for the weapon, is adjustable.

Even though weapon holsters of the aforementioned kind are configured primarily for carrying hand firearms and particularly pistols, they can in principle also be used for carrying other weapons, for example, knives, and optionally also certain tools, for example, hammers carried on the belt by a tradesman, a technician, or a mountaineer, for example, and to be drawn comfortably with one hand from the holster. Since the problem of quick adjustment of the draw angle to be explained in more detail in the following between a position that is comfortable when seated and a position that is expedient when standing upright is encountered mainly when carrying weapons and particularly hand firearms, the holster described herein is referred to as weapon holster without the application being limited thereby to holsters for carrying weapons.

The aforementioned adjustability of the draw angle serves not only for holding the weapon at an angle that is suitable for the weapon carrier, respectively, in order to quickly draw the weapon but also to move the weapon, for example, when being seated in an emergency response vehicle, into a position that is not disturbing to the weapon carrier, in which position, in case the weapon is a hand firearm, the barrel extends almost parallel, for example, to a belt to which the weapon holster is attached. This enables the weapon carrier to then buckle up without problems in the emergency response vehicle.

In case of the weapon holster disclosed in the aforementioned U.S. patent, for this purpose between the holster plate and the holster receptacle a latching joint unit is provided in which a locking projection positive-lockingly engages one of several locking recesses that define different draw angles and are partially complementary to the projection. For adjusting the draw angle the positive-locking connection must be released in that the locking projection is pushed by means of a separate actuating button out of the respective locking recess.

EP 1 479 998 A2 discloses a weapon holster in which, by displacement of a cylinder that positive-lockingly blocks a rotary element, pivoting of the weapon is possible into a position that is comfortable when seated, wherein the rotary element locks only in a single basic position. Therefore, after a one-time actuation of an actuating element that displaces the cylinder, the holster receptacle, without actuating the actuating element again, can be pivoted back into the predefined basic position, but an adjustability of the draw angle that is also desired is not realized.

U.S. Pat. No. 4,504,001 discloses a weapon holster of the old style, i.e., with a belt loop instead of the holster plate that is nowadays conventional wherein between holster receptacle and belt loop two disks are provided that are formed to have locking projections and locking recesses in such way that by releasing a fastening screw and rotation of belt loop and holster receptacle relative to one another and subsequent tightening of the fastening screw a certain draw angle can be fixedly adjusted. An adjustment of the draw angle without a tool or even pivoting of the holster receptacle into a position that is comfortable when seated is thus not possible.

FR 2 761 149 A discloses a weapon holster in which the draw angle is determined purely by frictional connection in that the holster plate and the holster receptacle are pressed against one another by intermediate positioning of a rubber ring that increases friction and by tightening a fastening screw.

U.S. 2002/0148865 A1 discloses a weapon holster in which a locking element that is pretensioned by a spring engages positive-lockingly locking recesses arranged in a circle. A similar weapon holster is also disclosed in DE 93 08 896 U1. In both holsters, for adjusting the draw angle it is required to release the positive locking connection by pushing the respective locking element that acts positive-lockingly out of the locking recess(es).

When the object is to only establish a certain draw angle, the method, disclosed in several of the aforementioned publications, of releasing a positive-locking latching action of a hinged connection, of whichever type, between holster receptacle and holster plate is not a problem because the person carrying the weapon generally can unhurriedly adjust the draw angle that is comfortable for him and therefore it is not important whether, as in case of U.S. Pat. No. 4,504,001, additional tools are required or, as in case of the other afore described publications, a certain actuating element must be actuated.

However, if, for example, an emergency response vehicle must be left quickly and possibly the weapon must be drawn from the holster, in the usually existing stress situation it may present an additional and possibly even life-endangering additional stress when, for restoring the draw angle from the position that is comfortable while being seated in an emergency response vehicle into a position that is suitable for drawing the weapon, an additional actuating element, for example, a button that pushes a locking element out of a positive-locking latching position, must be actuated.

### SUMMARY OF THE INVENTION

The invention has the object to provide a weapon holster of the aforementioned kind in which the draw angle is adjustable in a simple way without this requiring a separate tool and without a separate safety or actuating element having to be pushed down or actuated otherwise.

The invention has also the object to provide a latching joint unit that is in particular suitable for weapon holsters of the aforementioned kind and that enables a simple adjustment, without requiring a tool, of the relative position of two parts that are connected to one another by the latching joint unit.

The object is solved by a weapon holster with the features of claim 1 or with a latching joint unit with the features of claim 16. Advantageous embodiments and developments are the subject matter of the dependent claims, respectively.

The weapon holster according to the invention has the great advantage that a weapon held in the holster not only can be moved simply into a position that comfortably enables sitting in a vehicle but primarily, after exiting from the vehicle, that the weapon can also be moved with a single manipulation without actuation of any additional elements such as push buttons or the like into a draw position that is comfortable for the carrier of the weapon, wherein especially advantageously the torque that has to be applied for adjusting the draw angle is adjustable with respect to the user, respectively, and the application situation, respectively, in particular, the weight of the weapon, respectively.

Further details and advantages of the invention result from the following purely exemplary and non-limiting description of preferred embodiments with reference to the drawing.

### BRIEF DESCRIPTION OF THE DRAWINGS

FIG. 1 shows the rear side of a holster receptacle with adapter plate.

FIG. 2 shows the front side of a holster receptacle

FIG. 3 shows a weapon holster according to the invention with holster receptacle and holster plate in a side view.

FIG. 4 shows a holster plate with first joint element in a first embodiment of a latching joint unit in plan view.

FIG. 5 shows the holster plate according to FIG. 4 in lateral section view.

FIG. 6 shows an adapter plate with a second joint element of the first embodiment of a latching joint unit in lateral section view.

FIG. 7 shows an adapter plate according to FIG. 6 in plan view.

FIG. 8 shows the adapter plate according to FIG. 7 in plan view with removed joint element.

FIG. 9 shows the adapter plate according to FIG. 8 in section along the line IX-IX.

FIG. 10 shows the joint element according to FIG. 6 in plan view.

FIG. 11 shows the joint element according to FIG. 10 in section along the line XI-XI.

FIG. 12 shows a collar bushing for use with the adapter plate according to FIG. 8 in a side view.

FIG. 13 shows the collar bushing according to FIG. 12 in plan view.

FIG. 14 shows a holster plate for use with a first joint element of a second embodiment of a latching joint unit in lateral section view.

FIG. 15 shows the holster plate according to FIG. 14 in plan view.

FIG. 16 shows the holster plate according to FIG. 14 with attached adapter plate with a second joint element of a second embodiment of a latching joint unit in lateral section view.

FIG. 17 shows the adapter plate according to FIG. 16 in plan view.

FIG. 18 shows the adapter plate according to FIG. 17 in section view along the line XVIII-XVIII.

FIG. 19 shows an exploded view of the important elements of a latching joint unit according to the second embodiment.

### DESCRIPTION OF PREFERRED EMBODIMENTS

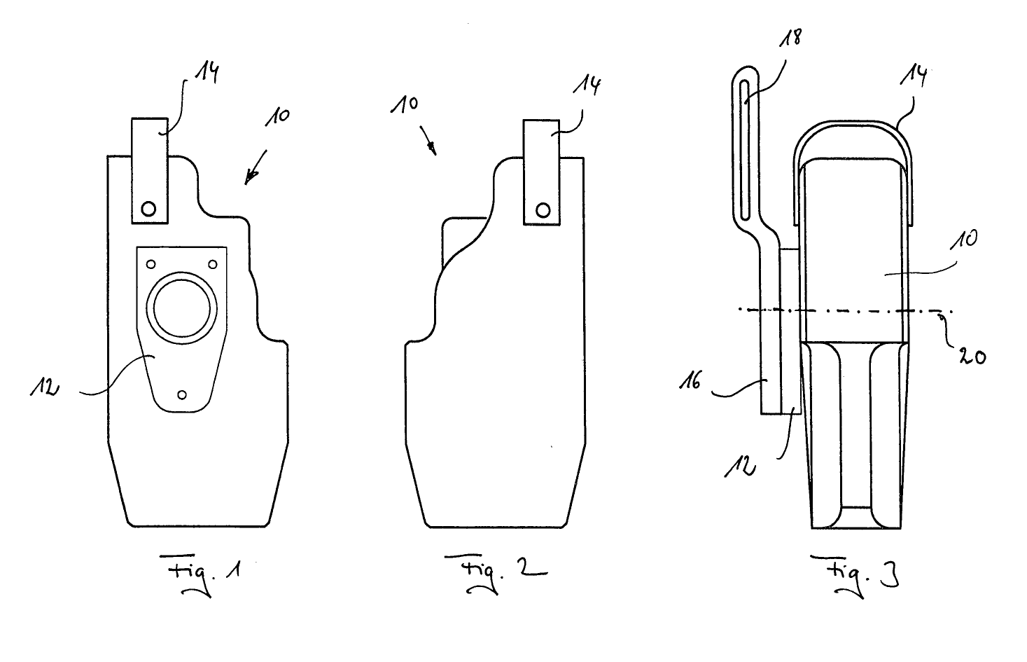

In FIGS. 1 and 2 the holster receptacle, indicated as a whole by 10, of a weapon holster according to the invention with adjustable draw angle is shown wherein FIG. 1 shows, as viewed by the carrier, the rear side that is facing the body of a carrier with adapter plate 12 and FIG. 2 the exterior side of the holster receptacle 10 for receiving a weapon, in particular a hand firearm, that is facing away from the body.

It is a so-called safety holster that, as is known in the art, is provided with two safety elements for securing a hand firearm, in particular a pistol, inserted into the holster receptacle of which only one, i.e., the strap 14, is illustrated.

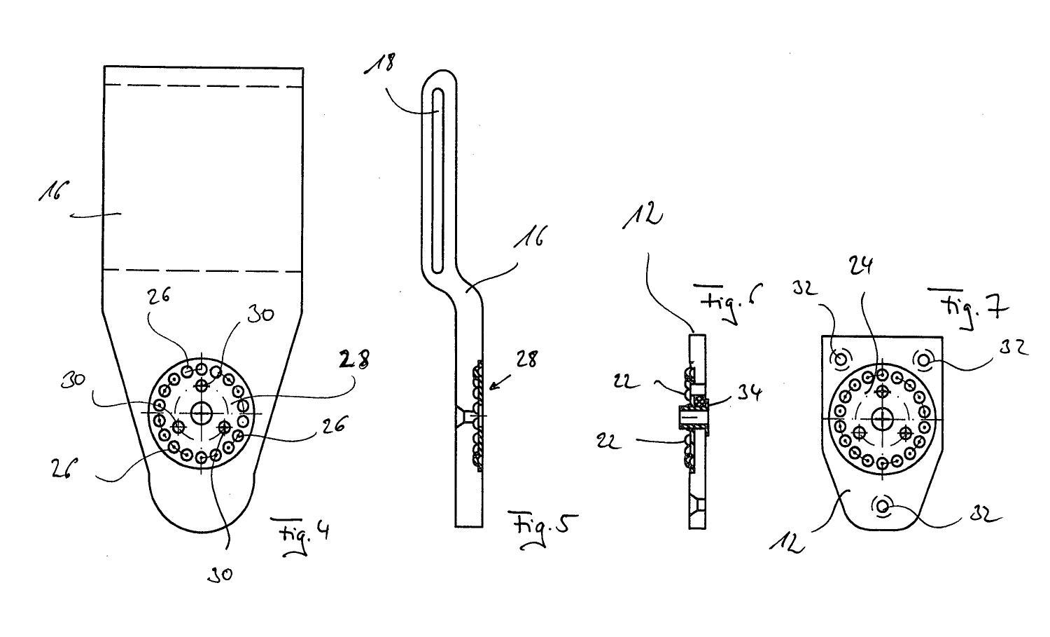

FIG. 3 shows in a side view the finish-mounted holster in which on the holster receptacle 10 by means of the adapter plate 12 a holster plate 16 that serves for attaching the holster by means of the cutout 18 on a belt, a duty belt or the like is attached so as to be rotatable about the axis of rotation indicated by dash-dotted line 20 so that the draw angle that is defined by the relative position between holster plate 16 and holster receptacle 10 is adjustable. For this purpose, between holster plate 16 and holster receptacle 10 locking projections and locking recesses that are partially complementary thereto are provided that are engaged by the locking projections for determining various draw angles, wherein the adjustment of the draw angle is exclusively adjustable by application of a torque that releases the locking projections from the locking recesses and rotation of the holster plate and holster receptacle relative to one another about the axis of rotation and wherein the torque is adjustable.

As can be seen in FIG. 3, the axis of rotation 20 is preferably arranged such that it is positioned in the vicinity of the center of gravity of a weapon to be carried in the holster. This has the advantage that no restoring moments are generated, as they are known e.g. from clock pendulums, that attempt to readjust the draw angle selected by the user. Holster plate and holster receptacle are comprised preferably of hard plastic material wherein in particular the holster receptacle may be lined or coated with a protective coating for the weapon and/or the clothing of the carrier of the holster. The receptacle can also be made of other materials, for example, leather, but primarily a hard plastic material is preferred for safety holsters.

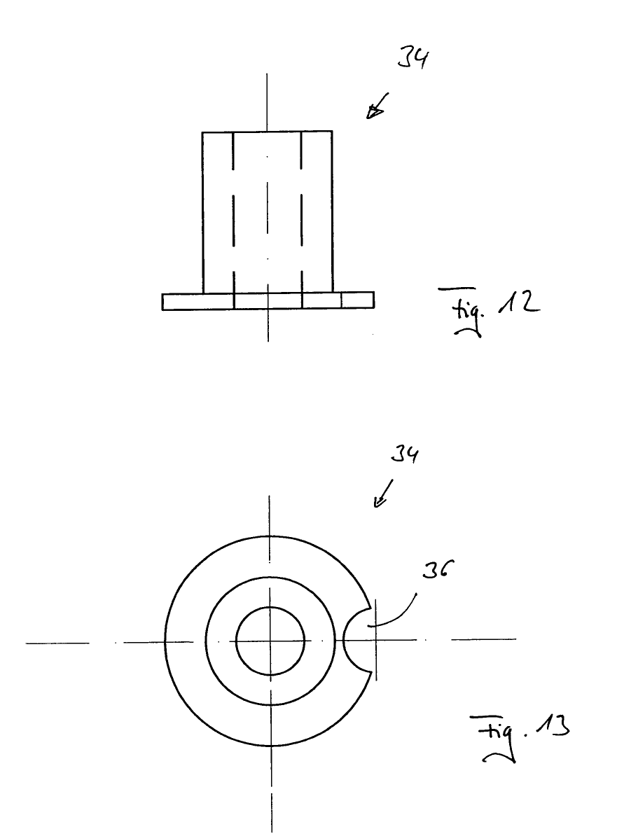

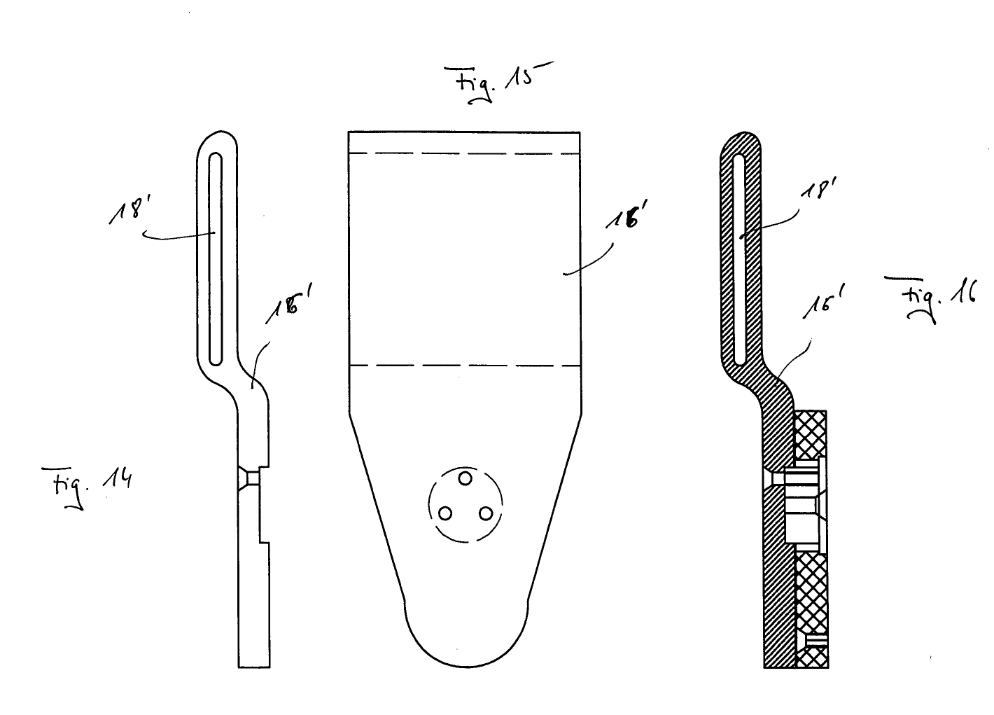

In FIGS. 4 through 13 the important parts of a weapon holster are illustrated in which a first embodiment of a latching joint unit is employed that is characterized in that the locking projections 22, of which for reasons of simplicity only a few are provided with reference numerals, are formed on a first disk 24 (see particularly FIGS. 10 and 11) and the locking recesses 25, of which for reasons of simplicity also only a few are provided with reference numerals, are formed on a second disk 28 and are pretensioned relative to one another.

Here, the locking projections 22 are embodied as spherical segments and are arranged on the disk 24 in a circle about the axis of rotation wherein the locking recesses 26 on the disk 28 are arranged in a complementary way relative thereto.

Preferably, approximately 15 to 25 locking projections and a corresponding number of locking recesses are provided. The disks 24 and 28 are comprised preferably of spring steel.

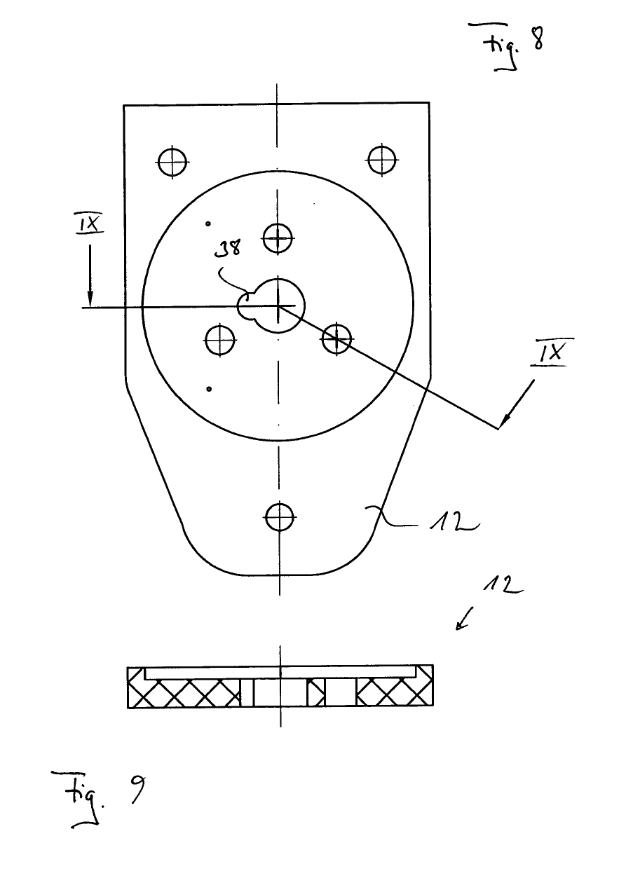

As can be seen particularly well in FIG. 5, on the holster plate 16 a recess for receiving one of the two disks, namely in this embodiment the disk 28 with the recesses 26, is provided. The disk 28 is secured in the recess in a suitable way, for example, by gluing or is screw-connected to the holster plate by means of the fastening bores 30.

In this embodiment, the disk 24 is provided on the adapter plate 12 that is to be attached to the holster receptacle wherein the adapter plate 12 comprises several fastening bores 32 for attachment on the holster receptacle. Of course, the reverse arrangement of the disks 24 and 28 is possible, i.e., an attachment of the disk 24 on the holster plate 16. Also, it is possible to mount one of the disks directly on the holster receptacle. Providing an adapter plate has however manufacturing-technological advantages and enables also to retrofit already existing holster receptacles in an inexpensive way.

The two disks 24 and 28 in this embodiment are pretensioned relative to one another by means of a screw/collar bushing connection in which a screw (not illustrated) penetrates one of the disks, here the disk 28, and is screwed into a collar bushing 34 that penetrates the other one of the disks, here the disk 24, and if provided with an appropriate inner thread.

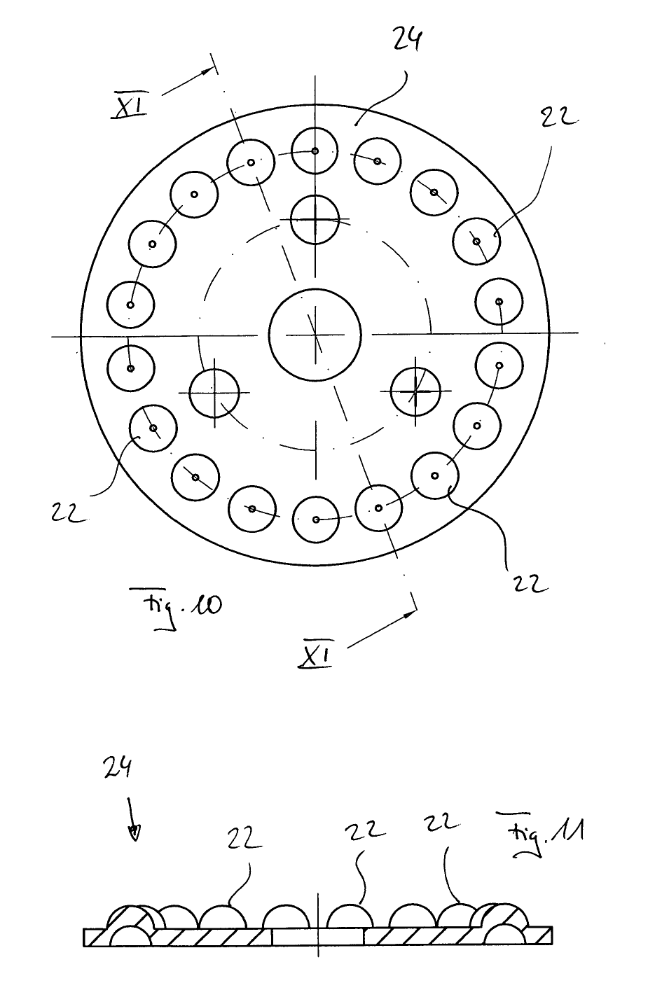

The collar bushing 34 in this embodiment has a recess 36 that serves as an anti-rotation device for which purpose also in the adapter plate 12 a corresponding recess 38 (FIG. 8) is provided. Into the recesses, a short cylinder can then be inserted that then secures the collar bushing against rotation.

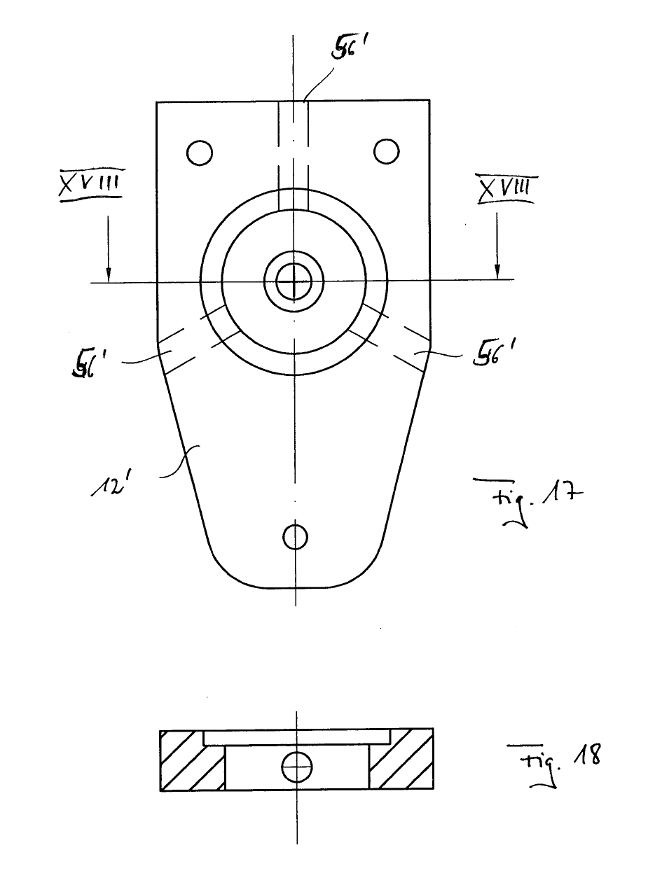

In the FIGS. 14 to 19 the important parts of a weapon holster are illustrated in which a second embodiment of a latching joint unit is used, or the important parts of such a latching joint unit in which the locking projections are formed by spheres 40 (FIG. 19).

The latching joint unit illustrated in FIG. 19 serves for providing a connection of two parts, in particular a holster plate and a holster receptacle, enabling rotation about an axis of rotation 20 and securable in various rotational positions. In this connection, the latching joint unit comprises two joint elements 42 and 44, rotatable about the axis of rotation 20, each to be attached to one of the parts to be connected in an articulated way to one another, and comprises between these joint elements locking projections and partially complementary locking recesses that are engaged by the locking projections for securing different rotational positions. The adjustment of the rotational positions in this connection is done exclusively by application of a torque that releases the locking projections from the locking recesses and rotation of the joint elements relative to one another about the axis of rotation.

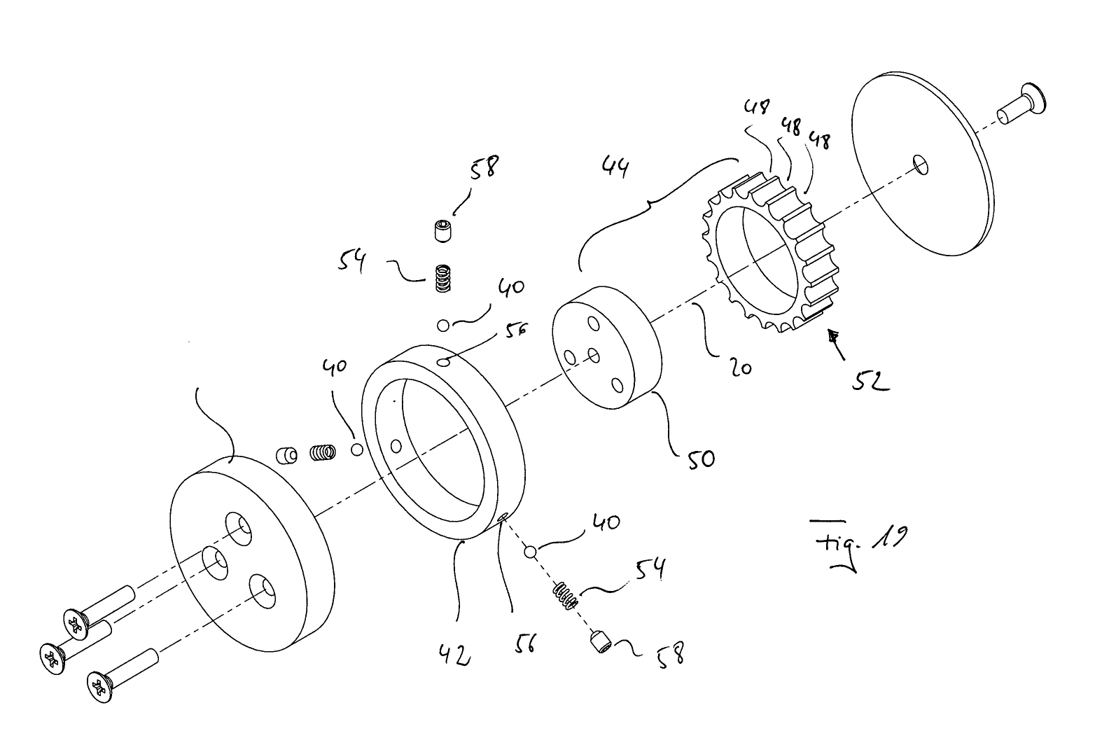

In FIG. 19 the latching joint unit is illustrated in general form in which one of the joint elements 42 serves for receiving the spheres 40 and, as shown in FIG. 17, may be, but must not be, embodied in the form of an adapter plate 12′.

On the other joint element a locking bushing can be attached or, as shown in FIG. 19, it may even form the other joint element 44 wherein the locking bushing is provided with several locking projections 48 of which for reasons of simplicity only a few are provided with reference numerals.

In the embodiment illustrated in FIG. 19 the locking bushing 44 is of a two-part configuration and is comprised of a ring 52 of steel provided with locking recesses and mounted on a cylinder 50 made of light metal, in particular, aluminum; this has advantages with respect to manufacturing technology and weight.

The locking projections, as shown in FIG. 19, are formed by spheres 40 that are pretensioned by spring elements 54 in the direction toward the locking recesses so that the torque can be adjusted continuously.

The spheres 40 are arranged for this purpose in bores 56 that are provided radially relative to the axis of rotation 20 in the joint element 42 wherein, as mentioned before, the illustration of FIG. 19 is more of a principal nature. In particular, the joint element 42 in reality is significantly thicker than shown so that the bores 56 have the required length for receiving the spheres and spring elements.

In the proper mounting state, one sphere 40 each is then received in one of the bores 56, respectively, at the end of the respective bore closest to the axis of rotation 20 and is pretensioned by a coil spring 54 in the direction of the locking bushing 44 that is attached to the other joint element or forms the other joint element and is provided with several locking recesses wherein a screw, in particular, a set screw 58, closes off the bore 56 at the ends facing away from the axis of rotation. It has been found to be advantageous when two to five, preferably three or four, bores that radially extend relative to the axis of rotation and an appropriate number of spheres are provided.

In the FIGS. 14 to 18 the use of a latching joint unit embodied in analogy to FIG. 19 in connection with a weapon holster is illustrated wherein the holster plate 16′ is embodied for receiving the locking bushing 44 and the adapter plate 12′ is embodied as a joint element like the joint element 42 and has bores 56′ for receiving spheres, spring elements and set screws, by means of which the torque required for adjusting the draw angle can be adjusted continuously.

### INDUSTRIAL APPLICABILITY

The industrial applicability of weapon holsters and latching joint units of the kind disclosed herein is apparent. However, it should be noted that the application implies also a new method of doing business, i.e., the industrial retrofitting of existing weapon holsters with the latching joint unit of the present invention so that for these holsters the draw angle can be adjusted also without requiring tools. This method is therefore expressly also encompassed by the invention and in those countries whose national law allow for this, is claimed as worthy of protection.

What is claimed is:

1-21. (canceled)

22. A weapon holster with adjustable draw angle, the weapon holster comprising:
a holster plate for attachment of the weapon holster on a belt;
a holster receptacle adapted to receive a weapon, wherein the holster plate and the holster receptacle are connected to one another so as to be rotatable relative to one another about an axis of rotation in such a way that a draw angle that is defined by a relative position between the holster plate and the holster receptacle is adjustable;
wherein between the holster plate and the holster receptacle locking projections and locking recesses are provided, wherein the locking recesses are partially complementary to the locking projections and wherein the locking projections engage the locking recesses for securing the draw angle;
wherein the draw angle is adjusted exclusively by applying a torque that releases the locking projections from the locking recesses and by rotating the holster plate and the holster receptacle relative to one another about the axis of rotation; and
wherein the torque is adjustable.

23. The weapon holster according to claim 22, wherein the axis of rotation is arranged proximal to a center of gravity of a weapon to be carried in the weapon holster.

24. The weapon holster according to claim 22, wherein the weapon holster is a safety weapon holster for hand firearms and comprises two safety elements for securing a hand firearm carried in the weapon holster.

25. The weapon holster according to claim 22, wherein at least one of the holster plate and the holster receptacle is comprised of hard plastic material.

26. The weapon holster according to claim 22, comprising a first disk and a second disk, wherein the locking projections are formed on the first disk and the locking recesses are formed on the second disk, wherein the first and second disks are pretensioned relative to one another.

27. The weapon holster according to claim 26, wherein in the holster plate or in the holster receptacle a recess for receiving one of the first and second disks is provided and wherein, for securing the other one of the first and second disks, an adapter plate is provided that is to be attached to the holster receptacle or to the holster plate.

28. The weapon holster according to claim 26, wherein the first and second disks are pretensioned relative to one another by a screw/collar bushing connection comprising a screw and a collar bushing, wherein the screw penetrates one of the first and second disks and is screwed into the collar bushing that penetrates the other one of the first and second disks and has a thread matching a thread of the screw.

29. The weapon holster according to claim 26, wherein the locking projections are formed as spherical segments and arranged on the first disk in a circle about the axis of rotation and the locking recesses are arranged in an arrangement complementary thereto on the second disk.

30. The weapon holster according to claim 29, wherein 10 to 30 of the locking projections and a matching number of the locking recesses are provided.

31. The weapon holster according to claim 30, wherein 15 to 25 of the locking projections are provided.

32. The weapon holster according to claim 26, wherein the first and second disks are comprised of spring steel.

33. The weapon holster according to claim 22, wherein the locking projections are spheres that are pretensioned by spring elements in the direction of the locking recesses.

34. The weapon holster according to claim 33, comprising an adapter plate provided with bores extending in the adapter plate radially relative to the axis of rotation, wherein the adapter plate is configured for attachment on the holster receptacle or the holster plate and wherein the spheres are arranged in the bores.

35. The weapon holster according to claim 34, comprising a locking bushing attached to the holster plate and provided with the locking recesses and surrounded by the adapter plate, wherein the spheres each are arranged in one of the bores, respectively, at an end of the bores closest to the axis of rotation, wherein a coil spring is provided in each one of the bores for pretensioning the spheres in the direction toward the locking bushing, wherein a screw is provided for each one of the bores and closes off the bores at the end remote from the axis of rotation, respectively.

36. The weapon holster according to claim 35, wherein the locking bushing is of a two-part configuration and is comprised of a ring of steel provided with locking recesses and a cylinder of light metal such as aluminum, wherein the ring is mounted on a circumference of the cylinder.

37. The weapon holster according to claim 34, wherein two to five of the bores extending radially to the axis of rotation and a matching number of the spheres are provided.

38. The weapon holster according to claim 37, wherein three or four of the bores extending radially to the axis of rotation and a matching number of the spheres are provided.

39. A latching joint unit for connecting two parts so as to be rotatable relative to one another and securable in different rotational positions, the latching joint unit comprising:
two joint elements rotatable relative to one another about an axis of rotation and adapted to be attached, respectively, to one of the two parts that are to be connected in an articulated way with one another;
wherein between the two joint elements locking projections and locking recesses are provided, wherein the locking recesses are partially complementary to the locking projections;
wherein the locking projections engages the locking recesses for securing the two joint elements in different rotational positions relative to one another;
wherein the different rotational positions are adjusted by applying a torque that releases the locking projections from the locking recesses and by rotating the two joint elements relative to one another about the axis of rotation; and
wherein the locking projections are formed by spheres that are pretensioned by spring elements in a direction toward the locking recesses so that the torque is adjustable continuously.

40. The latching joint unit according to claim 39, wherein the two parts are a holster plate for attachment of a holster on a belt and a holster receptacle for receiving a weapon.

41. The latching joint unit according to claim 39, wherein the spheres are arranged in bores that are provided radially relative to the axis of rotation in a first one of the joint elements.

42. The latching joint unit according to claim 41, wherein a second one of the joint elements comprises a locking bushing provided with the locking recesses and surrounded by the first joint element, wherein the spheres each are arranged in one of the bores, respectively, at an end of the bores closest to the axis of rotation, wherein a coil spring is provided in each one of the bores for pretensioning the spheres in the direction toward the locking bushing, wherein a screw is provided for each one of the bores and closes off the bores at the end remote from the axis of rotation, respectively.

43. The latching joint unit according to claim 42, wherein the locking bushing is of a two-part configuration and is comprised of a ring of steel provided with locking recesses and a cylinder of light metal such as aluminum, wherein the ring is mounted on a circumference of the cylinder.

44. The latching joint unit according to claim 42, wherein two to five of the bores extending radially to the axis of rotation and a matching number of the spheres are provided.

45. The latching joint unit according to claim 44, wherein three or four of the bores extending radially to the axis of rotation and a matching number of the spheres are provided.

46. A method of retrofitting a weapon holster, comprising the steps of:
mounting a latching joint unit according to claim 39 between a holster plate and a holster receptacle for providing an adjustable draw angle.
